(19) United States
(12) Patent Application Publication
(10) Pub. No.: US 2004/0144735 A1
(43) Pub. Date: Jul. 29, 2004

(54) Process for removing interstitual water from a wastewater sludge

(76) Inventors: Samuel L. Shepherd, Houston, TX (US); Arthur Austin, Oviedo, FL (US)

Correspondence Address: John S. Egbert, Harrison & Egbert, 7th Floor, 412 Main Street, Houston, TX, 77002, US

(21) Appl. No.: 10/228,382

(22) Filed: Aug. 27, 2002

(51) Int. Cl. C02F 1/00

(52) U.S. Cl. 210/769

(57) ABSTRACT

A process for removing water from sludge including passing the sludge through a chamber, injecting carbon dioxide gas under pressure into the chamber as the sludge passes through the chamber, and flashing the carbon dioxide-injected sludge through an orifice into a vessel so as to release carbon dioxide gas from the sludge. The flashed sludge is dewatered to remove water from the sludge. The carbon dioxide gas is injected at no less than 25 p.s.i.g. of pressure.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to wastewater treatment. More particularly, the present invention relates to processes for dewatering sludge prior to treatment. Furthermore, the present invention relates to processes for removing interstitual water from cellular material during wastewater treatment processes.

### BACKGROUND OF THE INVENTION

Sewage is composed of the liquid and water-carried wastes from residences, commercial buildings, industrial plants, and institutions, together with any groundwater, surface water and storm water which may be present. The terms “wastewater” and “sewage” are sometimes used interchangeably. The composition of sewage depends upon its origin and the volume of water in which the wastes are carried. Sewage which originates entirely from residential communities is made up of excreta, bathing and washing water, and kitchen wastes. Other wastes can be present from rural/agricultural sources and/or industrial or commercial establishments.

Modern sewage treatment is generally divided into three phases: primary, secondary and tertiary. Each of these steps produces sludge, which can be disposed of or used for various purposes. Sludge is the semiliquid mass removed from the liquid flow of sewage. Sludge will vary in amount and character with the characteristics of sewage and plant operation. Sludge from primary treatment is composed of solids usually having a ninety-five percent moisture content. The accumulated solid materials, or sludge, from sewage treatment processes amount to fifty to seventy pounds per person per year in the dry state or about one ton per year in the wet state. Sludge is highly capable of becoming putrid and can, itself, be a major pollutant if it is not biologically stabilized and disposed of in a suitable manner. Biological stabilization can be accomplished by either aerobic or anaerobic digestion. After digestion, sludge-drying beds are usually used.

In modern sewage treatment plants, mechanical dewatering of sludge by vacuum filters, centrifuges, belt presses, or other devices is becoming widespread. Many kinds of sludges are difficult to dewater with conventional dewatering equipment such as chamber filter presses, belt filter presses and other similar equipment. Therefore, prior conditioning is necessary so as to improve the capability for dewatering. In the past, such conditioning is generally achieved by the addition of one or several chemicals acting as flocculation agents. The capability for dewatering which has been achieved by conditioning will depend strongly upon the quantity, size and especially the structure and stability of the formed floc particles. Unfortunately, the use of such flocculation agents is a rather expensive process and, as such, it is considered desirable to use flocculants very sparingly.

One of the major problems associated with prior attempts to dewater sludge prior to introduction into such belt presses is the fact that a great deal of water is retained within the interstitual structures of the organisms. Typically, belt presses will only extract external water from the cell membranes. The belt presses are generally ineffective in extracting the interstitual water accumulated within the cell membranes. As a result, belt presses have been generally ineffective at removing a large amount of the water from the sludge. In order to fully remove the water from the sludge, it would be necessary to gain access to the interstitual water accumulated within the cell membrane walls of the cells within the wastewater sludge.

In the past, various patents have issued relating to dewatering processes. For example, U.S. Pat. No. 6,101,738, issued on Oct. 15, 2000 to G. Gleason, describes a sludge dewatering system in which the sludge is dewatered by introducing pressurized air into the sludge. The air serves to strip the sludge of its water and thereby increase the total solids captured with respect to time. The pressurized air is applied through the surfaces of the belt press so as to “blow” through the sludge accumulated upon the belt press.

U.S. Pat. No. 6,051,137, issued on Apr. 18, 200 to F. D. Deskins, describes a process of dewatering primary-treated sewage which includes the step of mixing the sewage with a coagulant or flocculant, such as an activated polymer. The sewage is then mixed and flocculated at conditions which involve extensive mixing turbulence of the sewage whereby part of the sewage is recycled so as to be subjected to mixing and flocculating. The pH of the sewage is chemically adjusted to the basic pH range. The sewage is applied to a sand bed whereby the flocculated solids in the sewage are separated from the liquid in the sewage. The flocculated solids located on the top of the sand bed are then air dried.

U.S. Pat. No. 5,961,827, issued on Oct. 5, 1999 to A. Bahr, describes an apparatus for dewatering sludge which includes a sludge chamber provided with filter areas having at least one sludge inlet connected to a device for forming a hydrostatic filtration pressure. The sludge chamber is formed by pressure plates that can be pressed against each other to create mechanical dewatering pressure. There is a predewatering stage containing filter areas which forms a compensation container and which is connected to a continuous sludge feed.

U.S. Pat. No. 5,885,445, issued on Mar. 23, 1999 to Andrews et al., describes a belt press for dewatering sludge. The press includes a camera to monitor the physical operation of a gravity belt section of the press. A numerical control device utilizes electromagnetic radiation received from the gravity belt section to control the physical operation of the belt section.

U.S. Pat. No. 5,770,056, issued on Jun. 23, 1998 to F. D. Deskins, is related to the later issued U.S. Pat. No. 6,051,137 and also describes the process of dewatering primary-treated sewage by adding a coagulant or a flocculant to the mixed sewage.

U.S. Pat. No. 5,366,622, issued on Nov. 22, 1994 to S. Geyer, describes a process for the dewatering of sludge which involves the addition of a flocculant to the sludge suspension. A pressure pipe is placed between a feed pump and dewatering equipment. There are a number of dosing points located along the pressure pipe so as to allow for the introduction of the flocculant at desired location during the feed of the sewage toward the dewatering equipment.

U.S. Pat. No. 4,767,537, issued on Aug. 30, 1988 to H. F. Davis, teaches the dewatering of sludge by the addition of nitrate ions to the treated sludge so as to generate microscopic bubbles of nitrogen gas that adhere to the sludge floe particles. This causes a reduction in density of the particles which, in turn, causes the particles to float to the top of a thickening tank. The process separates the sludge into an upper thickened layer and a lower free water layer.

It is an object of the present invention to provide a process for the dewatering of sludge which allows for the removal of the interstitual water from the cell membranes within the sludge.

It is another object of the present invention to provide a process which will reduce the water content of the sludge prior to passing to the belt press or other dewatering equipment.

It is another object of the present invention to provide a process which provides an acid treatment of the waste.

It is still a further object of the present invention to provide a process for the dewatering of sludge which is extremely cost effective.

It is a further object of the present invention to provide a process for the dewatering of sludge which is easy to use and install.

These and other objects and advantages of the present invention will become apparent from a reading of the attached specification and appended claims.

### BRIEF SUMMARY OF THE INVENTION

The present invention is a process for removing water from sludge comprising the steps of: (1) passing a sludge through a chamber; (2) injecting carbon dioxide gas under pressure into the chamber as the sludge passes through the chamber; and (3) flashing the carbon dioxide-injected sludge through an orifice and into a vessel so as to release the carbon dioxide gas from the sludge. Subsequent to these steps, the flashed sludge can be dewatered so as to further remove water from the sludge. The dewatered sludge can be treated so as to remove pathogens from the sludge. The removed water can be passed to a wastewater treatment facility for further treatment.

In the present invention, the carbon dioxide gas is injected at no less than 25 p.s.i.g. of pressure. In the preferred embodiment of the present invention, the chamber is a pipeline. The sludge is introduced into one end of the pipeline. The carbon dioxide gas is injected into the sludge adjacent one end of the pipeline. The pipeline will have a length suitable for allowing the carbon dioxide gas to reach equilibrium saturation within the sludge.

In the present invention, an alkaline material can be added to the flashed sludge prior to the step of passing to the dewatering equipment. In the preferred embodiment of the present invention, the alkaline material is lime. Also, in the present invention, an acid can be added to the sludge so as to reduce the pH of the sludge to less than six. This acid is added to the process subsequent to the step of injecting the carbon dioxide gas into the sludge. In the preferred embodiment of the present invention, the pH of the acid-added sludge will be approximately three. The acid can be either sulfamic acid, nitric acid, phosphoric acid, oxolic acid or sulfuric acid.

In the present invention, the released carbon dioxide gas can be reinjected into the chamber. A suitable pump is provided inline between the flash vessel and the chamber so as to cause the released carbon dioxide gas to be elevated in pressure to greater than 25 p.s.i.g.

It is important to note that, in the present invention, the gas can also be, in addition to carbon dioxide gas, nitrous oxide, nitrogen gas or nitrogen dioxide.

### BRIEF DESCRIPTION OF THE SEVERAL VIEWS OF THE DRAWINGS

FIG. 1 is a block diagram showing the process of the present invention.

### DETAILED DESCRIPTION OF THE INVENTION

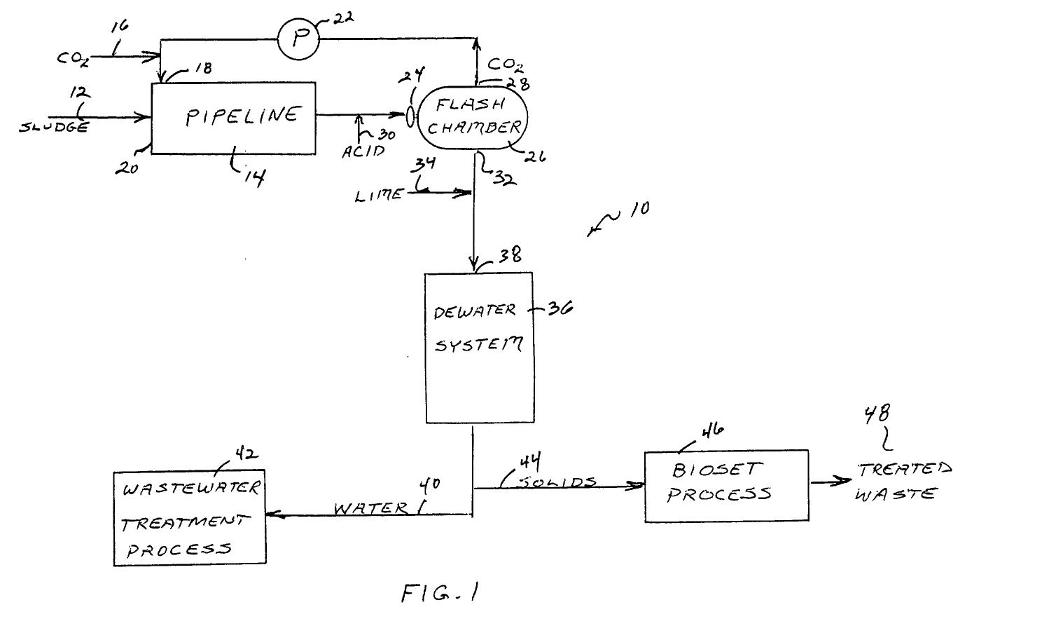

Referring to FIG. 1 there is shown the process 10 of the present invention for the dewatering of sludge prior to passing to wastewater treatment processes. Initially, in FIG. 1, it can be seen that the sludge 12 is illustrated as passing to a chamber, such as pipeline 14. The sludge 12 is a wastewater sludge having a relatively high water content. The pipeline 14 can be suitably closed so as to allow pressure elevations therein. The pipeline 14 will have suitable length so as to allow the sludge a proper residence time therein under the pressure of carbon dioxide gas 16 introduced through inlet 18 of the pipeline 14.

When the process 10 of the present invention is a continuous process, the carbon dioxide gas 16 will be injected through inlet 18 into the pipeline 14 adjacent one end 20 of the pipeline 14. As such, the carbon dioxide gas 16 is mixed with the sludge 12 immediately upon entrance into the pipeline. Within the concept of the present invention, it is important that the carbon dioxide gas 16 be introduced into the pipeline 14, along with the sludge 12, in a suitable volume so as to reach equilibrium saturation with the sludge. The pipeline 14 will have a length so as to provide a suitable residence time so that the mixture of carbon dioxide gas 16 and sludge 12 can occur therewithin.

In the preferred embodiment of the present invention, the carbon dioxide gas should be injected into the pipeline 14 through inlet 18 in an amount of 25 p.s.i.g. or greater. Experiments with the present invention have shown that when the carbon dioxide gas is injected under such pressures, the carbon dioxide gas will be dissolved within the sludge and into the interstitual water within the cell membranes. The carbon dioxide gas passes through the cell walls. Other gases, such as nitrogen dioxide, nitrogen gas, and possibly nitros oxide, can do likewise. Pump 22 is provided so as to suitably pressurize the carbon dioxide gas prior to introduction into pipeline 14.

After a suitable residence time within the pipeline 14, the carbon dioxide-injected sludge can pass outwardly of pipeline 14 through a restricted orifice 24 and into flash chamber 26. The flash chamber 26 is a vessel that is not pressurized or maintained under a negative pressure condition. As such, when the carbon dioxide-injected sludge passes through the restricted orifice 24, the carbon dioxide gas will be immediately released from saturation condition with the sludge. As a result, the carbon dioxide gas will pass outwardly of the flash chamber 26 through outlet 28.

Importantly, it has been found when the carbon dioxide-injected gas passes through the restricted orifice 24 and into the flash chamber 26, the carbon dioxide gas is released from the sludge similar to the manner in which carbon dioxide gas is released from soft drinks. As a result, any carbon dioxide gas which has accumulated within the interstitual surfaces of the cell walls will react explosively so as to tear through the cells walls and to release water therefrom. This rather violent action serves to remove the interstitual water from the sludge. Also, this violent reaction can serve to destroy those organisms that may be pathogenic.

In the present invention, an acid 30 can be injected into the carbon dioxide-injected sludge prior to introduction through the restricted orifice 24 of flash chamber 26. The acid will serve to lower the pH of the carbon dioxide-injected sludge to less than six. The acid 30 can include sulfamic acid, nitric acid, phosphoric acid, sulfamic acid, oxolic acid and sulfuric acid. Ideally, the pH of the carbon dioxide-injected sludge should be less than three but not less than two. The preferred pH range would be between two and six. The acid treatment of the carbon dioxide-injected sludge will operate to kill off certain types of the pathogens within the sludge. As a result, in combination with later treatment processes, the introduction of acid at this stage can be effective in killing potentially dangerous organisms within the sludge.

Since the carbon dioxide is released through outlet 28 of the flash chamber 26, the carbon dioxide can be reused by passage back to pump 22 and back into the pipeline 14 through the inlet 18. Supplemental carbon dioxide gas 16 can also be introduced into the inlet 18, as required, so as to achieve the necessary pressurization within the interior of the pipeline 14.

Subsequent to passing into the flash chamber 26, the gaseous component is passed outwardly of the outlet 28 of the flash chamber 26. The liquid component is passed outwardly through outlet 32. This liquid component is then treated with an alkaline material, such as lime. The lime 34 is introduced so as to neutralize the acidity of the liquid component as it is. The lime material 34 is introduced to the acidified liquid passing from the flash chamber 32 so as to neutralize the liquid. If the liquid were not neutralized, then it is likely that more expensive stainless steel components would be required for the present invention. If the cost of lime addition were to be avoided, then the dewatering system 36, along with the various pipelines, could be formed of such stainless steel materials.

The liquid component is then passed through the inlet 38 of the dewatering system 36. The dewatering system 36 can be any of a wide variety of known dewatering systems, such as belt presses and other mechanical dewatering devices. Since the cell walls have been punctured so that the liquid component in the interstitual areas has been removed, the dewatering system 36 will be much more effective in reducing the water content of the sludge. In FIG. 1, it can be seen that the water component 40 can be passed outwardly of the dewatering system 36 to a wastewater treatment process 42. The solids component 44 can be delivered to another sludge treatment process 46.

In the preferred embodiment of the present invention, the sludge treatment process 46 is known as the “BIOSET” (TM) process. The BIOSET (TM) process is an effective process for the removal of pathogens from the solids. Since the BIOSET (TM) process is an alkaline process, it works well in combination with the acid process imparted to the sludge material prior to the dewatering system. As a result, the organisms within the wastewater sludge are treated with an acid process, an alkaline process, and with a turbulent process. The turbulent process is the release of carbon dioxide from the sludge so as to penetrate membrane walls from the inside out. As a result, the end product, the (treated waste 48) should be of an extremely high quality free of pathogens and other dangerous organisms.

By completely dewatering the sludge, it is possible to get a drier finished product. The amount of space required for the shipment of the finished product will be greatly reduced. The amount of drying time would be also reduced. As will be appreciated, the lower the water content of the treated sludge, the more economical is the disposal process. Ideally, when treated with the BIOSET (TM) process, the finished product can be used for agricultural purposes.

The foregoing disclosure and description of the invention is illustrative and explanatory thereof. Various changes in the steps of the described process can be made within the scope of the present invention without departing from the true spirit of the invention. The present invention should only be limited by the following claims and their legal equivalents.

We claim:

1. A process for removing water from a sludge comprising:
passing a sludge through a chamber;
injecting carbon dioxide gas under pressure into said chamber as the sludge passes through said chamber; and
flashing the carbon dioxide-injected sludge through an orifice into a vessel so as to release the carbon dioxide gas from the sludge.

2. The process of claim 1, further comprising:
dewatering the flashed sludge so as to remove water from the sludge.

3. The process of claim 2, further comprising:
treating the dewatered sludge so as to remove pathogens from the sludge; and
passing the removed water from the sludge to a wastewater treatment facility.

4. The process of claim 1, said carbon dioxide gas being injected at no less than 25 p.s.i.g. of pressure.

5. The process of claim 4, said chamber being a pipeline, said step of passing comprising introducing the sludge into one end of said pipeline, said step of injecting comprising injecting carbon dioxide gas adjacent into said sludge adjacent said one end of said pipeline.

6. The process of claim 5, said pipeline having a length suitable for allowing the carbon dioxide gas to reach equilibrium saturation within the sludge.

7. The process of claim 2, further comprising:
adding an alkaline material to the flashed sludge prior to passing to the step of dewatering.

8. The process of claim 7, said alkaline material being lime.

9. The process of claim 1, further comprising:
adding an acid to the carbon dioxide-injected sludge so as to reduce a pH of said sludge to less than 6.

10. The process of claim 9, said pH being approximately 3.

11. The process of claim 9, said acid being selected from the group consisting of sulfamic acid, nitric acid, phosphoric acid, oxolic acid and sulfuric acid.

12. The process of claim 1, further comprising:
reinjecting the released carbon dioxide gas into the chamber.

13. A process for removing water from wastewater sludge comprising:
placing a sludge into a chamber;
injecting a gas under at least 25 p.s.i.g. of pressure into said chamber; and
flashing the gas from the chamber so as to release the gas from the sludge.

14. The process of claim 13, said gas selected from the group consisting of carbon dioxide, nitrous oxide, nitrogen gas and nitrogen dioxide.

15. The process of claim 13, further comprising:
adding an alkaline material to the flashed sludge.

16. The process of claim 13, further comprising:
adding an acid into the sludge so as to reduce a pH of the sludge to less than 6.

17. The process of claim 13, further comprising the step of:
dewatering the flashed sludge so as to remove water from the sludge.

18. The process of claim 13, said step of injecting the gas comprising:
injecting carbon dioxide gas into the sludge until the sludge reaches equilibrium saturation with the carbon dioxide gas.

19. A process for removing water from sludge comprising:
placing a sludge into a chamber;
injecting carbon dioxide gas under pressure into the chamber until the sludge approximately equals equilibrium saturation with the gas; and
flashing the gas from the sludge so as to release the gas from the sludge.

20. The process of claim 19, said step of flashing comprising:
passing the gas-injected sludge through an orifice of restricted diameter into a vessel.
